(19) United States
(12) Patent Application Publication
(10) Pub. No.: US 2026/0175629 A1
(43) Pub. Date: Jun. 25, 2026

(54) TIRE-PRESSURE MONITORING SYSTEM

(71) Applicant: Ford Global Technologies, LLC, Dearborn, MI (US)

(72) Inventors: Richard Johnston, Camano Island, WA (US); Da Li, Sammamish, WA (US); Tobias Bischoff, Pasadena, CA (US)

(73) Assignee: Ford Global Technologies, LLC, Dearborn, MI (US)

(21) Appl. No.: 18/989,168

(22) Filed: Dec. 20, 2024

(51) Int. Cl. B60C 23/04

(52) U.S. Cl. CPC B60C 23/0474; B60C 23/0401

(57) ABSTRACT

A computer includes a processor and a memory, and the memory stores instructions executable by the processor to determine an update function based on data indicating pressure in a tire of a vehicle over a most-recent time period, determine a current test statistic for the most-recent time period, and, in response to the current test statistic exceeding a threshold, output a message indicating low pressure of the tire. The update function lacks an input of temperature. The current test statistic is a function of the update function and a previous test statistic. The previous test statistic is for an immediately previous time period from the most-recent time period.

### BACKGROUND

A tire-pressure monitoring system (TPMS) is a system for monitoring the air pressure of tires of a vehicle. When the TPMS detects that one of the tires of the vehicle is inflated below a threshold, an indicator light on the instrument panel illuminates to inform a driver about the tire. TPMS uses pressure sensors mounted either inside or on an outer surface of each tire. Pressure sensors mounted inside the tires communicate using wireless short-range signals.

### BRIEF DESCRIPTION OF THE DRAWINGS

FIG. 1 is a diagrammatic top view of an example vehicle.

FIG. 2 is a flowchart of an example process for detecting a slow leak in a tire of the vehicle.

### DETAILED DESCRIPTION

This disclosure provides techniques for accurately detecting a slow tire leak in a tire of a vehicle using a tire-pressure monitoring system (TPMS). The TPMS can report data indicating pressure in the tire to a computer. The computer is programmed to determine an update function based on the data indicating the pressure in the tire over a most-recent time period, determine a current test statistic for the most-recent time period, and, in response to the current test statistic exceeding a threshold, output a message indicating low pressure of the tire. The update function lacks an input of temperature, thereby reducing complexity of the calculations and eliminating reliance on temperature sensors. The current test statistic is a function of the update function and a previous test statistic. The previous test statistic is for an immediately previous time period from the most-recent time period. The use of the previous test statistic can reduce a quantity of stored data by consolidating the effects of earlier data into, for example, a single scalar value. The amount of raw data indicating the pressure can be limited to a single time period. While using less data than other methods (e.g., a single time period of raw pressure data and no temperature data), the techniques described herein may still deliver lower false positives and lower false negatives, thereby enhancing the performance of the TPMSs.

A computer includes a processor and a memory, and the memory stores instructions executable by the processor to determine an update function based on data indicating pressure in a tire of a vehicle over a most-recent time period, determine a current test statistic for the most-recent time period, and, in response to the current test statistic exceeding a threshold, output a message indicating low pressure of the tire. The update function lacks an input of temperature. The current test statistic is a function of the update function and a previous test statistic. The previous test statistic is for an immediately previous time period from the most-recent time period.

In an example, the tire may be a target tire, and the instructions to determine the update function may include instructions to determine the update function based on a ratio between pressure of the target tire over the most-recent time period and pressure of a reference tire of the vehicle over the most-recent time period. In a further example, the update function may be based on a logarithm of the ratio. In a still further example, the logarithm may be a current logarithm, and the update function may be based on a difference between the current logarithm and a previous logarithm, the previous logarithm being a logarithm of a ratio of pressure of the target tire over the immediately previous time period and pressure of the reference tire over the immediately previous time period. In a yet still further example, the update function may be based on a hyperbolic tangent of an expression including the difference. In a continuing example, the update function may be an exponential of the hyperbolic tangent.

In another further example, the pressure of the target tire may be a mean pressure over the most-recent time period, and the pressure of the reference tire may be a mean pressure over the most-recent time period.

In another further example, the reference tire may be a first reference tire, and the instructions to determine the current test statistic may include instructions to average a first preliminary current test statistic determined using the first reference tire and at least one other preliminary current test statistic determined using a different reference tire than the first reference tire.

In an example, the update function may have at least one of a finite maximum value or finite minimum value.

In an example, the current test statistic may be a product of the update function and the previous test statistic.

In an example, the instructions may further include instructions to perform a sequential probability ratio test of the current test statistic versus the threshold.

In an example, the current test statistic may be based exclusively on pressure data from tires of the vehicle including the tire.

In an example, the instructions may further include instructions to recursively determine the current test statistic in subsequent time periods.

In an example, the current test statistic may lack inputs indicating conditions before the immediately previous time period other than the previous test statistic.

A method includes determining an update function based on data indicating pressure in a tire of a vehicle over a most-recent time period, determining a current test statistic for the most-recent time period, and, in response to the current test statistic exceeding a threshold, outputting a message indicating low pressure of the tire. The update function lacks an input of temperature. The current test statistic is a function of the update function and a previous test statistic. The previous test statistic is for an immediately previous time period from the most-recent time period.

In an example, the tire may be a target tire, and determining the update function may include determining the update function based on a ratio between pressure of the target tire over the most-recent time period and pressure of a reference tire of the vehicle over the most-recent time period.

In an example, the method may further include performing a sequential probability ratio test of the current test statistic versus the threshold.

In an example, the current test statistic is based exclusively on pressure data from tires of the vehicle including the tire.

In an example, the method may further include recursively determining the current test statistic in subsequent time periods.

In an example, the current test statistic may lack inputs indicating conditions before the immediately previous time period other than the previous test statistic.

With reference to the Figures, wherein like numerals indicate like parts throughout the several views, a vehicle computer 105 and/or remote computer 110 includes a processor and a memory, and the memory stores instructions executable by the processor to determine an update function based on data indicating pressure in a tire 115 of a vehicle 100 over a most-recent time period, determine a current test statistic for the most-recent time period, and, in response to the current test statistic exceeding a threshold, output a message indicating low pressure of the tire 115. The update function lacks an input of temperature. The current test statistic is a function of the update function and a previous test statistic. The previous test statistic is for an immediately previous time period from the most-recent time period.

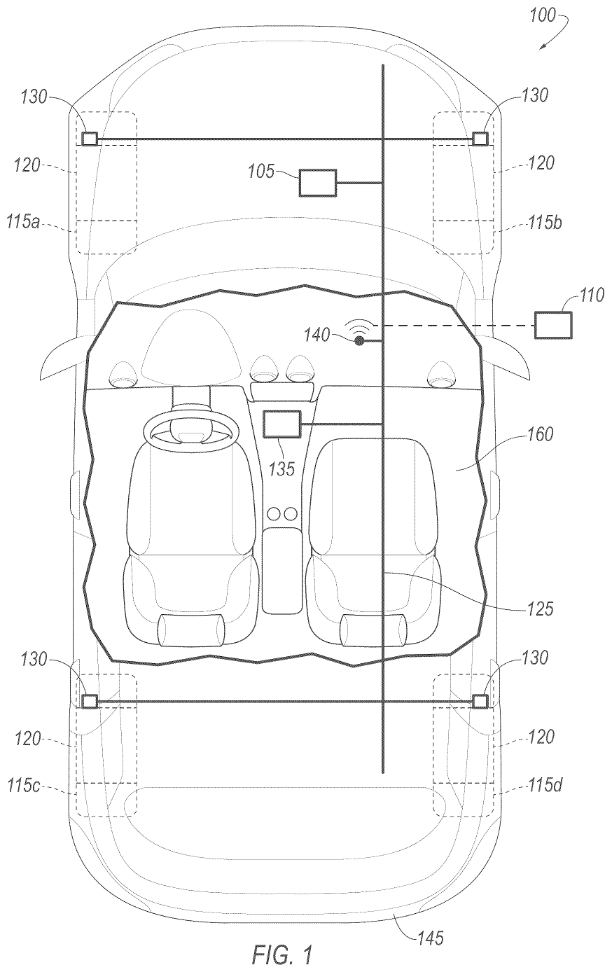

With reference to FIG. 1, the vehicle 100 may be any passenger or commercial automobile such as a car, a truck, a sport utility vehicle, a crossover, a van, a minivan, a taxi, a bus, etc. The vehicle 100 may include wheels 120, the tires 115, the vehicle computer 105, a communications network 125, tire-pressure monitoring systems (TPMSs) 130, a user interface 135, and a transceiver 140.

The vehicle computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The vehicle computer 105 can thus include a processor, a memory, etc. The memory of the vehicle computer 105 can include media for storing instructions executable by the processor as well as for electronically storing data and/or databases, and/or the vehicle computer 105 can include structures such as the foregoing by which programming is provided. The vehicle computer 105 can be multiple computers coupled together.

The vehicle computer 105 may transmit and receive data through the communications network 125. The communications network 125 may be a controller area network (CAN) bus, Ethernet, WiFi, Local Interconnect Network (LIN), onboard diagnostics connector (OBD-II), and/or any other wired or wireless communications network. The vehicle computer 105 may be communicatively coupled to the TPMSs 130, the user interface 135, the transceiver 140, and other components via the communications network 125.

The vehicle 100 includes a plurality of wheels 120, typically four wheels 120. Each wheel 120 is rotatable relative to a body 145 of the vehicle 100. The wheel 120 is radially symmetric and includes two radially symmetric flanges (not shown) for mounting a tire 115. The wheel 120 may be formed of a nonflexible material (e.g., a metal such as steel or aluminum).

The vehicle 100 includes a tire 115 mounted on each wheel 120 (e.g., a left front tire 115a, a right front tire 115b, a left rear tire 115c, and a right rear tire 115d). Each tire 115 is an inflatable ring mounted to the respective wheel 120. The tire 115 provides shock absorption and traction. The tire 115 and the wheel 120 define a toroidally shaped inflation chamber that may be filled with pressurized inflation medium, such as air. The inflation chamber has a toroidal shape. The tire 115 may be formed of synthetic or natural rubber, or other elastomeric materials that provide sufficient elasticity, durability, and grip. The tire 115 may also include cords (not shown) running through the elastomeric material and/or chemical compounds added to the elastomeric material.

The vehicle 100 includes a respective TPMS 130 for each tire 115. The TPMS 130 may be a direct TPMS sensor (i.e., a pressure sensor). Each TPMS 130 may be positioned to monitor the pressure of the respective inflation chamber defined by the respective tire 115. The TPMS 130 may communicate using wireless short-range signals with the communications network 125 and the vehicle computer 105.

The user interface 135 presents information to and receives information from an operator of the vehicle 100. The user interface 135 may be located on an instrument panel in a passenger compartment of the vehicle 100, and/or wherever may be readily seen by the operator. The user interface 135 may include dials, digital readouts, screens, speakers, and so on for providing information to the operator, such as human-machine interface (HMI) elements such as are known. The user interface 135 may include buttons, knobs, keypads, microphone, and so on for receiving information from the operator.

The transceiver 140 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 140 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), a first responder, a mobile device associated with the operator of the vehicle 100, etc. The transceiver 140 may be one device or may include a separate transmitter and receiver.

The remote server may be the remote computer 110. The remote computer 110 may be spaced from the vehicle 100. The remote computer 110 is a microprocessor-based computing device such as a generic computing device including a processor and a memory. The memory of the remote computer 110 can include media for storing instructions executable by the processor as well as for electronically storing data and/or databases, and/or the remote computer 110 can include structures such as the foregoing by which programming is provided. The remote computer 110 can be multiple computers coupled together. The remote computer 110 may be associated with a manufacturer or a fleet operator of the vehicle 100.

The techniques described below may be performed by the vehicle computer 105 and/or the remote computer 110. In the case of the remote computer 110, the vehicle computer 105 may instruct the transceiver 140 to transmit the pressure data or the results of earlier processing steps to the remote computer 110, and the remote computer 110 may then perform the later processing steps. The term “computer” as used herein may refer to the vehicle computer 105, the remote computer 110, or the vehicle computer 105 and the remote computer 110 collectively.

As a general overview, the computer 105, 110 receives data from the TPMSs 130 over the course of a time period. At the conclusion of each time period, the computer 105, 110 may determine the mean pressure over the time period for each tire 115. Then, for each tire 115, the computer 105, 110 may determine an observable of the pressure, which indicates a change in the pressure from the previous time period, as compared to one or more of the other tires 115. The computer 105, 110 determines an update function for each tire 115 based on the respective observable. For each tire 115, the computer 105, 110 then applies the update function to a test statistic from the previous time period, resulting in a test statistic for the current time period. Finally, the computer 105, 110 determines whether to output a message indicating a low pressure of each tire 115 based on the test statistic for that tire 115.

The computer 105, 110 receives the data indicating the pressures in the respective tires 115. For example, the TPMSs 130 may send values of the pressures in the respective tires 115 via the communications network 125 at regular intervals. The intervals may be set in the TPMSs 130. The values may be the pressures as measured in the interiors of the tires 115, without normalization.

The determinations described below may be performed once each time period. A “time period” is a length of time, in this case, the length of time over which the raw data is gathered for the calculations described below. The lengths of the time periods may be even (i.e., the same for each period) or uneven. The lengths may be chosen to sufficiently lengthy for gathering pressure data for averaging and sufficiently frequent to detect slow leaks, for example, an even period of 1 day. The time period for which the calculations are performed below is referred to as a most-recent time period, as that time period is the most recent to have completed before the calculations. As described below, some values in the calculations are carried over from what is referred to as an immediately previous time period, as that time period is the most recent to have completed before the most-recent time period. The most-recent time period is described with a subscript n, and the immediately previous time period is described with a subscript n−1.

The computer 105, 110 is programmed to determine a mean pressure for each tire 115 over the most-recent time period. For example, for each tire 115, the computer 105, 110 may determine an arithmetic average of the pressure data gathered over the most-current time period, such as in the following expression:

$${p}_{n}^{i} = {\sum }_{t = 0}^{T - 1} {p}_{raw , t}^{i}$$

in which p is pressure, the subscript n is an index of the time period, the superscript i is an index of the tires 115, the subscript t is an index of the intervals within the time period at which the data points of pressure are recorded, T is the total number of intervals in the time period, and the subscript raw indicates that the pressure was a value received from the respective TPMS 130 (referred to herein as “raw pressure data”).

The steps described below may be performed independently for each of the tires 115 of the vehicle 100. The tire 115 for which the steps are being performed is referred to as the target tire 115. One or more of the other tires 115 may be used as reference tires 115 that are compared with the target tire 115.

The computer 105, 110 is programmed to determine a ratio between pressure of the target tire 115 over the most-recent time period and pressure of a reference tire 115 of the vehicle 100 over the most-recent time period, and to determine a logarithm of the ratio, as given in the following expression:

$$log ( \frac{{p}_{n}^{ref}}{{p}_{n}^{targ}} )$$

in which the superscript ref indicates that the pressure is for the reference tire 115, and the superscript targ indicates that the pressure is for the target tire 115. This logarithm is referred to as a current logarithm to indicate that the logarithm is for the most-recent time period n. The computer 105, 110 may use the mean pressures over the most-recent time period n for the target tire 115 and reference tire 115.

The computer 105, 110 is programmed to determine an observable for the target tire 115 based on the current logarithm. The observable serves as the gathered data point for the most-recent time period, to be used for updating the test statistic below. The observable may include a difference between the current logarithm and a previous logarithm. The previous logarithm is a logarithm of a ratio of the pressure of the target tire 115 over the immediately previous time period n−1 and the pressure of the reference tire 115 over the immediately previous time period n−1. The difference may be normalized by the duration of the most-recent time period, resulting in the observable. For example, the observable may be given by the following expression:

$${x}_{n} = \frac{1}{{h}_{n}} ( log ( \frac{{p}_{n}^{ref}}{{p}_{n}^{targ}} ) - log ( \frac{{p}_{n - 1}^{ref}}{{p}_{n - 1}^{targ}} ) )$$

in which xₙ is the observable for the most-recent time period n, and hₙ is the duration of the most-recent time period n. This expression provides a comparison of how the pressure in the target tire 115 has changed from the immediately previous time period n−1 to the most-recent time period n with how the pressure in the reference tire 115 has changed in the same timeframe.

The computer 105, 110 is programmed to determine the update function. For example, the computer 105, 110 may determine the update function as a function taking the observable as an argument. The computer 105, 110 thereby determines the update function based on the steps above to arrive at the observable, including the data indicating the pressures in the target tire 115 and the reference tire 115 over the most-recent time period, the ratio between those pressures, the current logarithm, the difference between the current logarithm and the previous logarithm, and the observable.

The update function may have at least one of a finite maximum value or finite minimum value. In other words, for all values of the argument of the update function, the update function does not exceed the finite maximum value or fall below the finite minimum value. The argument of the update function incorporates the magnitude of change in the pressure (e.g., of the observable). The update function may increase toward the finite maximum value as the argument increases and/or decrease toward the finite minimum value as the argument decreases. For example, the update function may be based on a hyperbolic tangent of an expression including the difference (e.g., the observable). A hyperbolic tangent function asymptotically approaches 1 as the argument increases toward infinity and asymptotically approaches −1 as the argument decreases toward negative infinity. For example, the update function may be an exponential of the hyperbolic tangent, as given in the following expression (in which, equivalently, a logarithm is applied to the left-hand side rather than an exponential to the right-hand side):

$$log L ( {x}_{n} ) = λtanh ( \frac{{x}_{n}}{λ} - 1 )$$

in which L is the update function and λ is a hyperparameter. The hyperparameter is chosen to minimize false positive and false negative rates using the test statistic below (e.g., λ=1).

The computer 105, 110 is programmed to determine the current test statistic for the most-recent time period. The current test statistic is a function of the update function and a previous test statistic for the immediately previous time period. For example, the current test statistic may be a product of the update function and the previous test statistic (e.g., of the previous test statistic added to 1), as in the following expression:

$${R}_{n} = ( {R}_{n - 1} + 1 ) L ( {x}_{n} )$$

in which Rₙ is the current test statistic, and Rₙ₊₁ is the previous test statistic. The current test statistic may thus be a Shiryaev-Roberts statistic. This format for the current test statistic can limit what data is retained from time periods before the most-recent time period. The only data that may be used from before the most-recent time period may be the previous test statistic and the mean pressures of the tires 115 over the immediately previous time period. Data from earlier time periods are incorporated into the previous test statistic and thus does not need to be retained, reducing how much data is stored and processed.

The use of an update function with finite maximum and minimum values (such as the hyperbolic tangent) can limit the potentially obscuring effect on the test statistic from reinflating the target tire 115. To take one example, if the target tire 115 has a slow leak and an operator refills the target tire 115 up to a recommended pressure once every few time periods, then the average pressure in the target tire 115 over time will be close to the recommended pressure. A method that averages the pressure over time may not detect the slow leak in this situation. The update function herein caps the contribution of the reinflations to the value of the current test statistic, thereby revealing the contributions of decreases in pressure from the slow leak.

The current test statistic may be a preliminary current test statistic. For each target tire 115, the computer 105, 110 may determine multiple preliminary current test statistics as described above, with the only difference being that each preliminary current test statistic is determined using a different one of the other tires 115 as the reference tire 115. For example, if the target tire 115 is the left front tire 115a, the computer 105, 110 may determine a first preliminary test statistic using the right front tire 115b as the reference tire 115, a second preliminary test statistic using the left rear tire 115c as the reference tire 115, and a third preliminary test statistic using the right rear tire 115d as the reference tire 115. The computer 105, 110 may average the preliminary current test statistics together to arrive at a total current test statistic, as in the following expression:

$${R}_{n} = \frac{1}{3} {\sum }_{i = 1}^{3} {R}_{n}^{i}$$

in which Rₙ is the total current test statistic and

$${R}_{n}^{i}$$

is the preliminary current test statistic using the ith tire 115 as the reference tire 115.

The computer 105, 110 may recursively determine the current test statistic in subsequent time periods. At each time period, the value of n increases by one. The current test statistic Rₙ becomes the previous test statistic Rₙ₋₁, and the mean pressures of the tires 115 over the most-recent time period n become the mean pressures of the tires 115 over the immediately previous time period n−1. The computer 105, 110 may then perform the determinations as described above. If the tire 115 is experiencing a slow leak, the current test statistic Rₙ may drift away from an equilibrium value over the course of multiple time periods.

Beneficially, the determinations described above are limited in what data is inputted, reducing demands on the computer 105, 110 for storing or processing large quantities of data. For example, the current test statistic may be based exclusively on pressure data from tires 115 of the vehicle 100. The update function (as well as the other determinations above) may lack an input of temperature. The use of the reference tires 115 implicitly incorporates the effects of temperature and other environmental conditions. Environmental conditions such as temperature will likely affect the tires 115 approximately equally. Thus, comparing the target tire 115 versus the reference tires 115 compensates for environmental conditions.

For another example, the current test statistic may lack inputs indicating conditions before the immediately previous time period other than the previous test statistic. The current test statistic accumulates changes each recursion. As described above, all the remaining inputs are from either the most-recent time period n or the immediately previous time period n−1. No inputs from the time periods n−2 or earlier are used. The effects of the time periods n−2 and earlier are reflected in the value of the previous test statistic Rₙ₋₁.

The computer 105, 110 may determine whether the current test statistic exceeds a threshold. The threshold may be chosen to be sufficiently far from the equilibrium value of the test statistic to indicate that the pressure has decreased from a slow leak over multiple time periods. For example, decreasing pressure over time periods can cause the test statistic to drift downward, so the threshold may be chosen to be sufficiently less than the equilibrium value to indicate consistent pressure decreases. If the threshold is below the equilibrium value, the test statistic may exceed the threshold by falling below the threshold. The computer 105, 110 may perform a sequential probability ratio test of the current test statistic versus the threshold. A sequential probability ratio test involves repeatedly updating the test statistic and comparing the test statistic to the threshold. At each time period, the computer 105, 110 may recursively update the current test statistic as described above and determine whether the current test statistic exceeds the threshold.

The computer 105, 110 is programmed to, in response to the current test statistic exceeding the threshold, output a message indicating low pressure of the target tire 115. For example, the vehicle computer 105 may output the message by actuating the user interface 135. The vehicle computer 105 may actuate the user interface 135 to illuminate a light on a dashboard the vehicle 100. The light may be a light specifically for low tire pressure. Alternatively or additionally, the vehicle computer 105 may actuate the user interface 135 to emit a sound such as a chime through a speaker of the user interface 135. Alternatively or additionally, the vehicle computer 105 may actuate the user interface 135 to display a message on a screen of the user interface 135. The message may state that one of the tires 115 has low pressure. Alternatively or additionally, the remote computer 110 may output the message remotely from the vehicle 100 (e.g., to a fleet operator). As a result of the message, the operator or fleet operator of the vehicle 100 may patch or replace the tire 115 experiencing the slow leak.

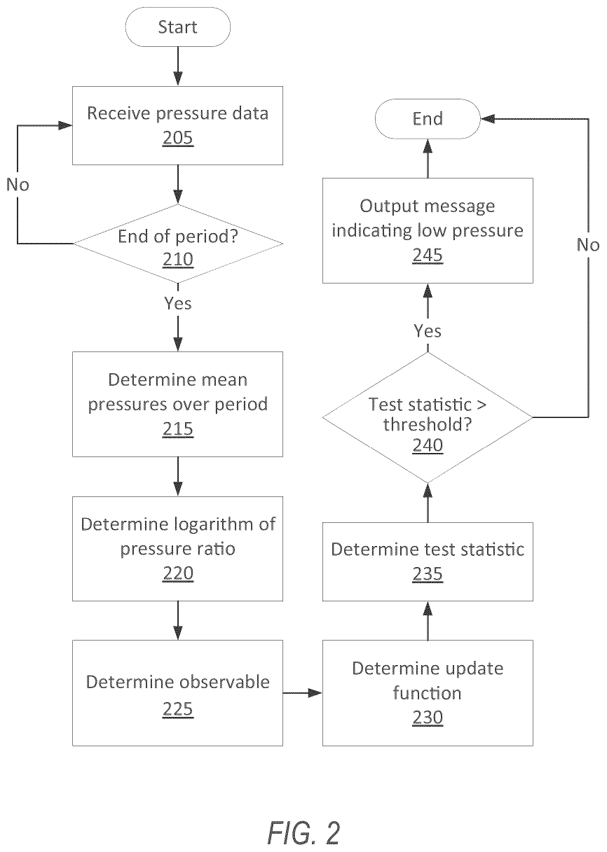

FIG. 2 is a flowchart illustrating an example process 200 for detecting a slow leak in a tire 115 of the vehicle 100. The memory of the computer 105, 110 stores executable instructions for performing the steps of the process 200 and/or programming can be implemented in structures such as mentioned above. The process 200 may be performed each time period. As a general overview of the process 200, the computer 105, 110 receives the raw pressure data from the TPMSs 130. Once the most-recent period ends, the computer 105, 110 determines the mean pressures for the tires 115 over the most-recent time period. For each combination of target tire 115 and reference tire 115, the computer 105, 110 determines the logarithm of the ratio between the mean pressure of the target tire 115 and the mean pressure of the reference tire 115 over the most-recent time period, determines the observable, and determines the update function. For each tire 115 as the target tire 115, the computer 105, 110 determines the test statistic. In response to any of the test statistics exceeding the threshold, the computer 105, 110 outputs a message indicating low pressure of the respective target tire 115.

The process 200 begins in a block 205, in which the computer 105, 110 receives the pressure data from the TPMSs 130 each interval, as described above.

Next, in a decision block 210, the computer 105, 110 determines whether a time period has just ended. In response to the time period ending, the time period becomes the most-recent time period, and the process 200 proceeds to a block 215. Otherwise, the process 200 returns to the block 205 to receive the pressure data for the next interval.

In the block 215, the computer 105, 110 determines the mean pressure of each tire 115 over the most-recent time period, as described above.

Next, in a block 220, the computer 105, 110 determines the logarithm of the ratio between the mean pressure of the target tire 115 over the most-recent time period and the mean pressure of the reference tire 115 of the vehicle 100 over the most-recent time period, as described above. The computer 105, 110 may perform this step for each combination of target tire 115 and reference tire 115 on the vehicle 100.

Next, in a block 225, the computer 105, 110 determines the observable, as described above. The computer 105, 110 may perform this step for each combination of target tire 115 and reference tire 115 on the vehicle 100.

Next, in a block 230, the computer 105, 110 determines the update function, as described above. The computer 105, 110 may perform this step for each combination of target tire 115 and reference tire 115 on the vehicle 100.

Next, in a block 235, the computer 105, 110 determines the current test statistic, as described above. The computer 105, 110 may perform this step for each tire 115 on the vehicle 100 as the target tire 115.

Next, in a decision block 240, the computer 105, 110 determines whether each current test statistic exceeds a threshold, as described above. In response to at least one of the current test statistics exceeding the threshold, the process 200 proceeds to a block 245. In response to none of the current test statistics exceeding the threshold, the process 200 ends.

In the block 245, the computer 105, 110 outputs a message indicating low pressure of the tire(s) 115 for which the current test statistics exceeded the threshold, as described above. After the block 245, the process 200 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. The adjectives “first,” “second,” and “third” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
determine an update function based on data indicating pressure in a tire of a vehicle over a most-recent time period, the update function lacking an input of temperature;
determine a current test statistic for the most-recent time period, the current test statistic being a function of the update function and a previous test statistic, the previous test statistic being for an immediately previous time period from the most-recent time period; and
in response to the current test statistic exceeding a threshold, output a message indicating low pressure of the tire.

2. The computer of claim 1, wherein the tire is a target tire, and the instructions to determine the update function include instructions to determine the update function based on a ratio between pressure of the target tire over the most-recent time period and pressure of a reference tire of the vehicle over the most-recent time period.

3. The computer of claim 2, wherein the update function is based on a logarithm of the ratio.

4. The computer of claim 3, wherein the logarithm is a current logarithm, and the update function is based on a difference between the current logarithm and a previous logarithm, the previous logarithm being a logarithm of a ratio of pressure of the target tire over the immediately previous time period and pressure of the reference tire over the immediately previous time period.

5. The computer of claim 4, wherein the update function is based on a hyperbolic tangent of an expression including the difference.

6. The computer of claim 5, wherein the update function is an exponential of the hyperbolic tangent.

7. The computer of claim 2, wherein the pressure of the target tire is a mean pressure over the most-recent time period, and the pressure of the reference tire is a mean pressure over the most-recent time period.

8. The computer of claim 2, wherein the reference tire is a first reference tire, and the instructions to determine the current test statistic include instructions to average a first preliminary current test statistic determined using the first reference tire and at least one other preliminary current test statistic determined using a different reference tire than the first reference tire.

9. The computer of claim 1, wherein the update function has at least one of a finite maximum value or finite minimum value.

10. The computer of claim 1, wherein the current test statistic is a product of the update function and the previous test statistic.

11. The computer of claim 1, wherein the instructions further include instructions to perform a sequential probability ratio test of the current test statistic versus the threshold.

12. The computer of claim 1, wherein the current test statistic is based exclusively on pressure data from tires of the vehicle including the tire.

13. The computer of claim 1, wherein the instructions further include instructions to recursively determine the current test statistic in subsequent time periods.

14. The computer of claim 1, wherein the current test statistic lacks inputs indicating conditions before the immediately previous time period other than the previous test statistic.

15. A method comprising:
determining an update function based on data indicating pressure in a tire of a vehicle over a most-recent time period, the update function lacking an input of temperature;
determining a current test statistic for the most-recent time period, the current test statistic being a function of the update function and a previous test statistic, the previous test statistic being for an immediately previous time period from the most-recent time period; and
in response to the current test statistic exceeding a threshold, outputting a message indicating low pressure of the tire.

16. The method of claim 15, wherein the tire is a target tire, and determining the update function includes determining the update function based on a ratio between pressure of the target tire over the most-recent time period and pressure of a reference tire of the vehicle over the most-recent time period.

17. The method of claim 15, further comprising performing a sequential probability ratio test of the current test statistic versus the threshold.

18. The method of claim 15, wherein the current test statistic is based exclusively on pressure data from tires of the vehicle including the tire.

19. The method of claim 15, further comprising recursively determining the current test statistic in subsequent time periods.

20. The method of claim 15, wherein the current test statistic lacks inputs indicating conditions before the immediately previous time period other than the previous test statistic.
